(19) United States
(12) Patent Application Publication
(10) Pub. No.: US 2024/0123917 A1
(43) Pub. Date: Apr. 18, 2024

(54) MODULAR PASSENGER COMPARTMENT TRIM

(71) Applicant: PSA AUTOMOBILES SA, Poissy (FR)

(72) Inventors: Laurent RIVIERRE, PARIS (FR); Frederic DONNADIEU, BART (FR); Didier MONIER, VIEUX CHARMONT (FR); Marc AUDION, PARIS (FR)

(21) Appl. No.: 18/548,163

(22) PCT Filed: Feb. 10, 2022
(86) PCT No.: PCT/FR2022/050241

§ 371 Date: Aug. 28, 2023

(30) Foreign Application Priority Data
Mar. 23, 2021 (FR) 2102874

(51) Int. Cl. B60R 13/08; B60N 3/04

(52) U.S. Cl. CPC B60R 13/083; B60N 3/042

(57) ABSTRACT

The invention relates to a trim assembly (1) of a motor vehicle, comprising a passenger compartment mat (3) extending between a visible face (4) and a reverse face (5), the mat (3) comprising a side contour surface (6) that joins said faces, the assembly (1) comprising a soundproofing element (7a), which is designed to occupy the space (8a) comprised between a floor (9a) of the passenger compartment (2) of the vehicle and the reverse side (5) when the mat (3) is installed in the vehicle, the assembly (1) comprising at least one trim element (13) designed to at least partially conceal a side rail (10a) of the vehicle. The mat (3) is designed to be positioned in the passenger compartment (2) of the vehicle with the contour surface (6) positioned opposite at least a portion of the side rail (10a), the trim element (13) being designed to conceal, when it is installed on the side rail (10a), a portion of the visible face (4) of the mat (3).

### CROSS-REFERENCE TO RELATED APPLICATIONS

This application is the US National Stage under 35 USC § 371 of International Application No. PCT/FR2022/050241, filed Feb. 10, 2022, which claims the priority of the French application No. 2102874 filed on Mar. 23, 2021, the content (text, drawings and claims) of both said applications being incorporated herein by reference.

### BACKGROUND

The technical field relates to trim assemblies for motor vehicle passenger compartments. It also relates to kits making it possible to form several assemblies, each being adapted to a particular vehicle, and finally it relates to vehicles equipped with such assemblies.

It is increasingly common for a motor vehicle to be offered to customers in several power system versions such as thermal energy, hybrid energy or electrical energy power systems. Each version of such a vehicle generally has specific features which involve structural differences between each version, in particular under the hood and in the passenger compartment. Thus, the floor of the passenger compartment is often different from one version to another in order to accommodate, for example, batteries for an electric or hybrid version or else to allow the passage of an exhaust pipe of a thermal engine. Thus, generally the passenger compartment of the vehicle has a different volume specific to each version of the vehicle. This diversity of passenger compartments means that automobile manufacturers must design and produce multiple different versions of most of the trim elements that are installed in different passenger compartments of different versions of the vehicle. These trim elements, which are presented in several versions, generally comprise trim floor mats and side rail trim.

This diversity necessarily causes an increase in the costs of development and production as well as complication of the supply logistics and the assembly lines of the different versions of the vehicle.

Thus, there is a need to reduce the diversity of the trim elements that constitute the trim of the various versions of passenger compartments of different versions of a vehicle.

### SUMMARY

The object is to overcome the problems described above. In this technical context, one aim is to provide a trim assembly for trimming a vehicle passenger compartment that minimizes the diversity of the trim elements used and which facilitates its assembly on the vehicle.

To this end, the present description relates to a trim assembly, for trimming a passenger compartment of a motor vehicle, comprising a passenger compartment mat extending between a visible face and a reverse face, the mat comprising a side contour surface joining said faces, the assembly further comprising a soundproofing element, designed to occupy at least part of the space between a floor of the passenger compartment of the vehicle and the reverse side when the mat is installed in the vehicle, the assembly further comprising at least one trim element designed to at least partially conceal a side rail of the vehicle, the assembly being characterized in that the mat is designed to be positioned in the passenger compartment of the vehicle, with the contour surface positioned opposite at least a portion of the side rail, the trim element being designed to conceal, when it is installed on the side rail, a portion of the visible face of the mat.

The described devices and methods also relate to a trim kit for a motor vehicle comprising an assembly and further comprising at least one additional soundproofing element, each being designed to be interchangeable with the soundproofing element of the assembly and to occupy a different volume.

Also described is a vehicle equipped with a trim assembly.

Finally, herein described is a method of trimming of an automotive vehicle consisting in having a trim kit and selecting one of the soundproofing elements of the kit to form an assembly adapted to the floor of the vehicle.

Thus, the assembly is adapted to the passenger compartment of the vehicle, in particular to the floor in order to offer a single passenger compartment mat for all the versions of the vehicle, the adaptation being made possible by virtue of the soundproofing element which can be chosen and adapted to at least partially fill the space between the passenger compartment floor and the reverse face of the mat. A kit is thus particularly useful insofar as the soundproofing element or each additional soundproofing element of the kit may be adapted to a particular version of the vehicle. By virtue of the kit, the trim of the passenger compartment of a vehicle having several versions is obtained with a single passenger compartment mat combined with a suitable soundproofing element, chosen in the kit, as indicated in the method. The diversity of the elements is further increased by virtue of the interface between the trim element and the passenger compartment mat; indeed, the passenger compartment mat, when installed, does not go back behind the side rail trim element as is usually the case, since the side contour surface is positioned opposite at least part of the side rail. This makes it possible to offer a single interface for all versions of the vehicle. Finally, the trim element, which conceals part of the visible face of the passenger compartment mat, makes it possible to prevent the side contour surface from becoming visible to the user of the vehicle during use. Thus, the attachment of the passenger compartment mat is superfluous and the assembly is less complex to assemble.

According to one embodiment of the assembly, the trim element has a heel projecting from the trim element and designed to conceal and press against the visible face of the passenger compartment mat. Such a heel increases the covering of the mat and avoids the visual quality defects caused when the side contour surface of the mat becomes visible to the user.

According to one possibility, the soundproofing element has at least one cavity accommodating a spacer designed to limit the compressibility of the soundproofing element. The soundproofing element is made of a porous and/or flexible material making it possible to absorb at least part of the sound waves passing through it. Also, when the thickness of the required soundproofing element is significant, a spacer makes it possible to limit the use of such a material, in particular its thickness. Indeed, without such a spacer, the soundproofing element would risk being too flexible, which could cause poor retention of the mat under the effect of a load by the user.

According to one embodiment of the kit, each soundproofing element has a different thickness. The thickness of each soundproofing element is adapted to a version of the vehicle.

### BRIEF DESCRIPTION OF THE FIGURES

The described methods and devices will be better understood upon reading the following detailed description, given solely by way of non-limiting example and with reference to the accompanying drawings, wherein:

FIG. 1 shows a perspective view of an assembly mounted on a chassis of a vehicle.

FIG. 2 shows a view in cross-section along the axis AA of FIG. 1 of a first version of the vehicle of FIG. 1, showing the floor of the vehicle and the assembly.

FIG. 3 shows a view in cross-section along the axis AA of FIG. 1 of a second version of the vehicle of FIG. 1, showing the floor of the vehicle and the assembly.

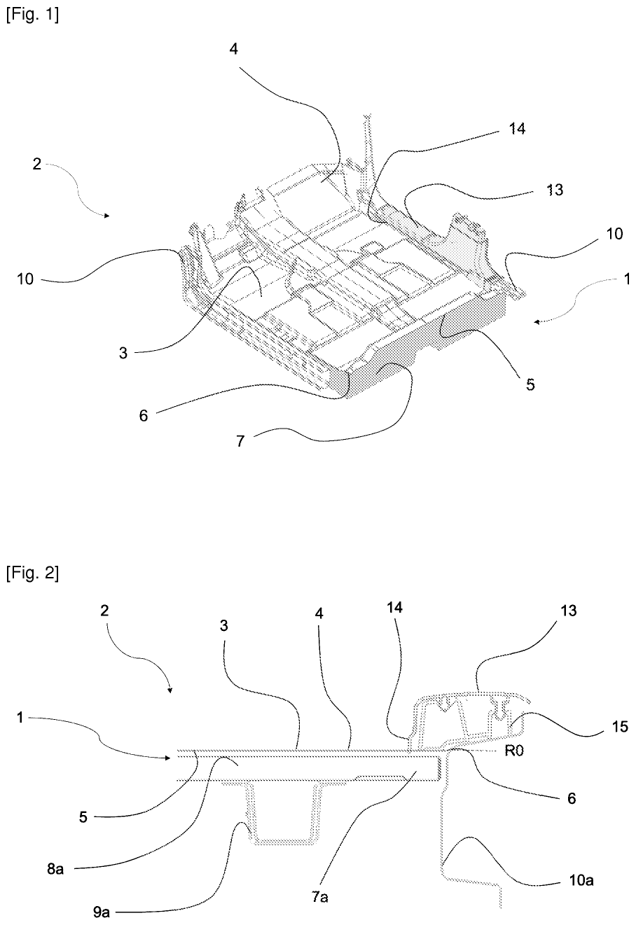

In these figures, the same references are used to designate the same elements.

### DETAILED DESCRIPTION

A trim assembly 1, shown in the figures, is used to trim a passenger compartment 2 of a motor vehicle having several versions related, for example, to various energy sources. The assembly 1 comprises a passenger compartment mat 3 that extends between a visible face 4 and a reverse face 5, shown in the figures. The visible face 4 and reverse face 5 are joined by a contour surface 6. The visible face 4 is for example provided with a carpet and/or any other provided decoration. The visible face 4 constitutes the face of the passenger compartment mat 3 that is visible at least in part by the user of the vehicle located in the passenger compartment 2.

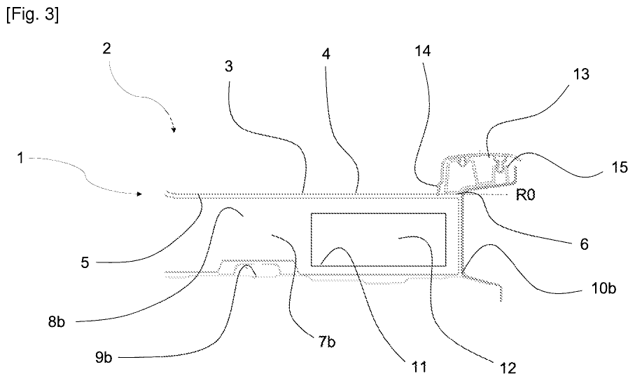

The assembly further comprises a soundproofing element 7 designed to occupy at least a part, preferably all, of the space 8 between a floor 9 of the passenger compartment 2 and the reverse face 5 as shown in FIGS. 2 and 3. The soundproofing element 7 is made of a porous or flexible material, for example a polymeric foam, capable of at least partially absorbing a sound wave passing through it. The soundproofing element 7 is obviously adapted to the space 8 which is specific to the vehicle version. In other words, for each version of the vehicle, the soundproofing element 7 has a shape adapted to the space 8 and has a specific volume. FIG. 2 shows a first version of the assembly 1 adapted to a first version of the passenger compartment 2, while FIG. 3 shows a second version of the assembly 1 adapted to a second version of the passenger compartment 2. Both passenger compartment versions 2 shown respectively in FIGS. 2 and 3 differ primarily in the shape of a side rail 10a, 10b and in their floor 9a, 9b. In particular, the floor 9a of the first version, shown in FIG. 2, differs from floor 9b of the second version, shown in FIG. 3, by their respective shapes and their positions relative to a reference point R0 of the side rail 10a, 10b of the passenger compartment 2 of the vehicle.

The passenger compartment mat 3 implemented for both versions shown in FIGS. 2 and 3 is the same. Likewise, in both versions shown in FIGS. 2 and 3, the contour surface 6 of the mat 3 is positioned opposite at least part of the side rail 10a,10b, more precisely opposite the reference point R0. Thus, a user successively using both versions of the passenger compartment 2 will note that the mat 3 is positioned at the same location relative to the side rail 10. The same user will not see that one of the floors 9a is positioned at a different height from the floor 9b of the other version.

To obtain this result, that is, the same positioning of the mat 3 with respect to the reference frame R0, the soundproofing element 7a of the first version has a thickness less than the thickness of the soundproofing element 7b of the second version, as shown in FIGS. 2 and 3. In order to limit the thickness of the soundproofing element material 7b, a cavity 11 is provided in the soundproofing element 7b to accommodate a spacer 12, made of rigid material, designed to limit the compression of the soundproofing element 7b during a load applied by a user.

The assembly 1 also comprises a trim element 13 of side rail 10 which is designed to at least partially conceal the side rail 10. The trim element 13 is designed and sized to conceal, when installed on the side rail 10, part of the visible face 4 of the mat 3. In particular, the trim element 13 has at its end arranged opposite the visible face 4 a heel 14 to increase the coverage of the mat 3. Thus, the heel 14 makes it possible to increase the coverage of the mat 3 without increasing the thickness of the trim element 13 of the side rail 10 in order to preserve the aesthetic appearance of the passenger compartment 2. The trim element 13 is held in position on the side rail 10 by a trim support 15, shown in FIGS. 2 and 3, attached in the side rail 10. The shape of the trim support 14 is adapted to take into account any variations in the shape of the side rail 10, from one version of passenger compartment 2 to another version, so that a trim element 13 common to all versions can be used. This is also made possible by the interface between the mat 3 and the trim element 13. Indeed, the mat 3 has no fastening to the side rail 10 or to the trim element 13.

A kit comprises the mat 13, the trim element 13 as well as, for example, both soundproofing elements 7a, 7b. Thus, depending on the version of the vehicle to be trimmed, the method consists in selecting the soundproofing element in the kit 7a, 7b adapted to the version of the vehicle.

Thus, the assembly 1 makes it possible to limit the diversity of parts necessary to trim two versions of a passenger compartment 2 since only the soundproofing element 7a, 7b must be developed and produced in as many versions as there are versions of the vehicle. The absence of attachment of the mat 3 on the trim element 13 also makes it possible to simplify the implementation of the method to trim the vehicle.

The described methods and devices are not limited to the embodiments of the assembly 1 of trim described above, only by way of example, but other embodiments can be designed by a person skilled in the art without departing from the frame and scope.

1. A trim assembly, for trimming a passenger compartment of a motor vehicle, comprising a passenger compartment mat extending between a visible face and a reverse face, the mat comprising a side contour surface joining said faces, the assembly further comprising a soundproofing element, adapted to occupy at least a part of the space comprised between a floor of the passenger compartment of the vehicle and the reverse face when the mat is installed in the vehicle, the assembly further comprising at least one trim element designed to at least partially conceal a side rail of the vehicle, wherein the mat is designed to be positioned in the passenger compartment of the vehicle with the contour surface positioned opposite at least part of the longitudinal member, the trim element being designed to conceal, when installed on the side rail, part of the visible face of the mat.

2. The assembly according to claim 1, wherein the trim element has a heel projecting from the trim element and designed to conceal and press on the visible face of the mat.

3. The assembly according to claim 1, wherein the soundproofing element has at least one cavity accommodating a spacer designed to limit the compressibility of the soundproofing element.

4. A trim kit for a motor vehicle comprising an assembly according to claim 1 and further comprising at least one additional soundproofing element, each being designed to be interchangeable with the soundproofing element of the assembly and to occupy a different volume.

5. The kit according to claim 4, wherein each soundproofing element has a different thickness.

6. A vehicle equipped with a trim assembly according to claim 1.

7. A trim method of an automotive vehicle equipped with a trim kit comprising a trim assembly according to claim 1, said trim kit comprising at least one additional soundproofing element, each additional soundproofing element being designed to be interchangeable with the soundproofing element of the assembly and to occupy a different volume, and selecting one of the soundproofing elements of the kit to form the assembly adapted to the floor of the vehicle.
